(19) United States
(12) Patent Application Publication
(10) Pub. No.: US 2026/0227313 A1
(43) Pub. Date: Aug. 6, 2026

(54) THRESHOLD LOGIC FOR FLOW CYTOMETRY WAVEFORM ANALYSIS

(71) Applicant: Beckman Coulter, Inc., Brea, CA (US)

(72) Inventors: Robert J. ZIGON, Carmel, IN (US); Larry MYERS, Greenfield, IN (US)

(73) Assignee: Beckman Coulter, Inc., Brea, CA (US)

(21) Appl. No.: 19/150,778

(22) PCT Filed: Jan. 22, 2024
(86) PCT No.: PCT/US2024/012410

§ 371 Date: Jul. 24, 2025

Related U.S. Application Data
(60) Provisional application No. 63/481,289, filed on Jan. 24, 2023.

(51) Int. Cl. G01N 15/1429; G01N 15/14; G01N 15/1434

(52) U.S. Cl. CPC G01N 15/1429; G01N 15/1434; G01N 15/1459; G01N 2015/1402; G01N 2015/1477

(57) ABSTRACT

A flow cytometry system for analyzing particles. The flow cytometry system detects waveform data from the particles passing through an interrogation zone. The waveform data is detected by the system without thresholding. The system receives a playback selection including a logical operator for determining when to begin thresholding the waveform data after detection. The system analyzes the waveform data based on the playback selection.

This application is being filed on Jan. 22, 2024, as a PCT International application and claims the benefit of and priority to U.S. Provisional Patent Application No. 63/481,289 filed on Jan. 24, 2023, the disclosure of which is hereby incorporated by reference in its entirety.

### BACKGROUND

Flow cytometry is a technique for detecting and analyzing chemical and physical characteristics of cells or particles in a fluid sample. For example, a flow cytometer may be used to assess cells from blood, bone marrow, tumors, or other body fluids. Typically, the sample is passed through a fluid nozzle which aligns particles in a single file line within a sheath fluid. A laser beam illuminates the particles as they pass through in single file to generate radiated light including forward scattered light, side scattered light, and fluorescent light. The radiated light can then be detected and analyzed to determine one or more characteristics of the particles.

### SUMMARY

In general terms, the present disclosure relates to analyzing particles using flow cytometry. In one possible configuration, a waveform data is detected without thresholding, and a playback selection includes a logical operator for determining when to begin thresholding the waveform data after detection. Various aspects are described in this disclosure, which include, but are not limited to, the following aspects.

One aspect relates to a flow cytometry system for analyzing particles, the flow cytometry system comprising: a light source for generating a light beam toward an interrogation zone; an optical system including detectors for detecting radiated light from particles passing through the light beam in the interrogation zone; and a processing circuitry having non-transitory computer readable storage media storing instructions which, when executed by the processing circuity, cause the processing circuitry to: detect waveform data from the particles passing through the interrogation zone, the waveform data detected without thresholding; receive a playback selection including a logical operator for determining when to begin thresholding the waveform data after detection; and analyze the waveform data based on the playback selection.

Another aspect relates to a method of performing a flow cytometry analysis, the method comprising: detecting waveform data from particles passing through an interrogation zone, the waveform data detected without thresholding; receiving a playback selection including a logical operator for determining when to begin thresholding the waveform data after detection; and analyzing the waveform data based on the playback selection.

Another aspect relates to a non-transitory computer readable medium comprising program instructions, which when executed by a processor, cause the processor to: detect waveform data from particles passing through an interrogation zone, the waveform data detected without thresholding; receive a playback selection including a logical operator for determining when to begin thresholding the waveform data after the waveform data is detected; and analyze the waveform data based on the playback selection.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawing figures, which form a part of this application, are illustrative of the described technology and are not meant to limit the scope of the disclosure in any manner.

FIG. 1 schematically illustrates an example of a flow cytometer system.

FIG. 2A shows an example of a particle entering an interrogation zone of the flow cytometer in the system of FIG. 1.

FIG. 2B shows an example of the particle passing through a central area of the interrogation zone of FIG. 2A.

FIG. 2C shows an example of the particle exiting the interrogation zone of FIG. 2A.

FIG. 3 illustrates an example of waveform data acquired from the flow cytometer in the system of FIG. 1 plotted with respect to a threshold value.

FIG. 4 schematically illustrates an example of a waveform analysis device of the flow cytometer system of FIG. 1.

FIG. 5 illustrates an example graphical user interface of the waveform analysis device of FIG. 4.

FIG. 6 illustrates an example of a graphical user interface that can be generated by the waveform analysis device of FIG. 4.

FIG. 7 illustrates another example of a graphical user interface that can be generated by the waveform analysis device of FIG. 4.

FIG. 8 schematically illustrates an example of a method 800 of providing a flow cytometry analysis by the flow cytometer system of FIG. 1.

FIG. 9 illustrates an example of a computing device for implementing aspects of the present disclosure such as those performed by the flow cytometer system of FIG. 1.

### DETAILED DESCRIPTION

Various embodiments will be described in detail with reference to the drawings, where like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

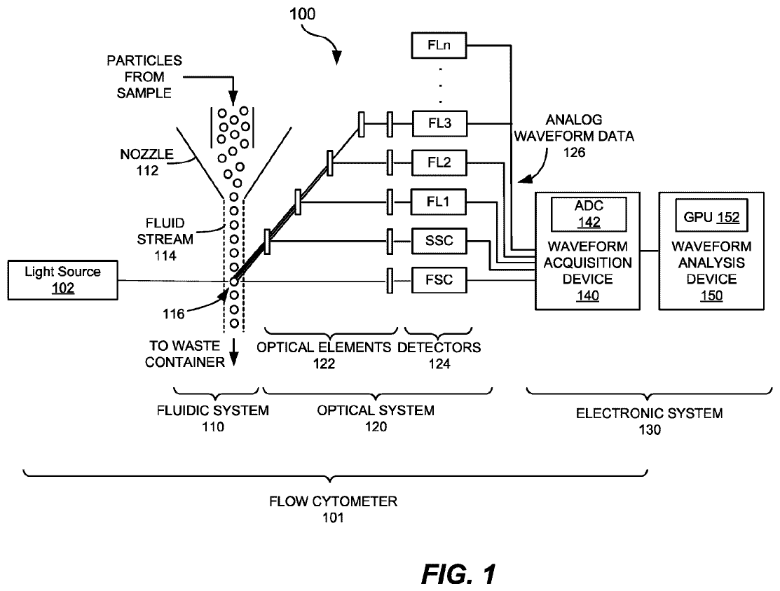

FIG. 1 schematically illustrates an example of a flow cytometer system 100. In some instances, the flow cytometer system 100 can include aspects and features described in U.S. Provisional Patent Application No. 63/410,984, entitled Flow Cytometry Waveform Processing, filed Sep. 28, 2022, U.S. Provisional Patent Application No. 63/481,293, entitled Control Variable Adjustment for Flow Cytometry Waveform Acquisition, filed Jan. 24, 2023, and U.S. Provisional Patent Application No. 63/481,298, entitled Doublet Analysis in Flow Cytometry, filed Jan. 24, 2023, which are herein incorporated by reference in their entireties.

In general, flow cytometry is a technique for measuring and analyzing properties of particles or cells when flowing in a fluid stream. Data from millions of particles or cells can be collected by the flow cytometer system 100 in a matter of minutes and displayed in a variety of formats. Illustrative example applications of flow cytometry include phenotyping to identify and count specific cell types within a population, analyzing DNA or RNA content within cells, determining presence of antigens on a surface or within cells, and assessing cell health status.

As shown in the illustrative example of FIG. 1, the flow cytometer system 100 generally includes three main component subsystems: a fluidic system 110, an optical system 120, and an electronic system 130. The fluidic system 110 includes a nozzle 112 which receives a sample containing particles or cells suspended in a fluid. The nozzle 112 creates and ejects a fluid stream 114 of the particles or cells arranged in a single file line. Each particle or cell passes through one or more beams of light produced by a light source 102. The point at which a particle or cell intersects with a light beam is known as an interrogation zone 116. In some examples, the light source 102 includes one or more lasers.

The optical system 120 includes the light source 102, optical elements 122, and detectors 124. At the interrogation zone 116, light from the light source 102 hits a particle or cell in the fluid stream 114 and scatters. The optical elements 122 direct the scattered light toward the detectors 124. The detectors 124 can include a forward scatter (FSC) detector to measure scatter in the path of the light source 102, a side scatter (SSC) detector to measure scatter at a ninety-degree angle relative to the light source 102, and one or more fluorescence detectors (FL1, FL2, FL3 . . . FLn) to measure the emitted fluorescence intensity at different wavelengths of light.

Generally, FSC intensity is proportional to the size or diameter of a particle due to light diffraction around the particle. FSC may therefore be used for the discrimination of particles by size. SSC, on the other hand, is produced from light refracted or reflected by internal structures of the particle and may therefore provide information about the internal complexity or granularity of the particle. By adding fluorescent labelling to a sample, different fluorescent signals/channels (e.g., green, orange, and red) can be analyzed for functional characteristics of a cell. For example, since T-cells present CD3 binding sites, a sample containing T-cells may be “stained” with anti-CD3 antibodies conjugated with a fluorescent molecule. As these cells pass through the interrogation zone 116, the light from the source light excites the fluorescent tag, or fluorochrome, to emit photons at a wavelength detectable by a fluorescence detector. The detectors 124 may therefore simultaneously measure several parameters and enable categorization of particles by their function based on detected wavelengths of light.

The electronic system 130 includes a waveform acquisition device 140 and a waveform analysis device 150. The waveform acquisition device 140 is communicatively coupled with the detectors 124 to receive analog waveform data 126 generated by the detectors 124. The waveform acquisition device 140 includes an analog-to-digital converter (ADC) 142 configured to digitize the waveform data.

The waveform analysis device 150 is configured to receive the digital waveform data and display it for a user of the flow cytometer system 100. In some embodiments, the waveform analysis device 150 comprises a computing device communicatively coupled with a flow cytometer 101, such as over a network. The flow cytometer 101 may include the fluidic system 110, optical system 120, and waveform acquisition device 140. In other embodiments, the waveform analysis device 150 is integrated with the flow cytometer 101.

Current flow cytometers use a field-programmable gate array (FPGA) in the waveform acquisition device to obtain information about individual particles passing through the light beam. The waveform acquisition device uses a single threshold value to determine when the output of the detectors begins conversion from analog to digital. Only a single threshold value can be used for a single run of a sample through the flow cytometer. The threshold value is a constant value and may be referred to as a voltage threshold value. As such, if or when a detector outputs a voltage value that crosses the threshold, digitization begins, and the digital value is sent to the FPGA. As waveform data is digitized, the FPGA computes the height, width, and area of each pulse. Besides the height, width, and area of each pulse, other data relating to the waveform, including data not exceeding the voltage threshold value, is not captured, stored, or otherwise available for analysis. Additionally, if a user wishes to adjust the threshold value, the experiment has to be re-run with the new threshold value, incurring costs in resources and time.

To address the above issues, the flow cytometer system 100 is improved with a graphics processing unit (GPU) 152. In the example illustrated in FIG. 1, the GPU 152 is shown included as a component of the waveform analysis device 150. The GPU 152 processes a continuous digital stream generated by the waveform acquisition device 140. The digital stream is continuous in that the waveform acquisition device 140 does not threshold the waveform data produced by the detectors 124. In contrast to current flow cytometry techniques, during an experiment, the waveform acquisition device 140 continuously digitizes the analog waveform data 126 at a high rate (e.g., 1 GHz) without thresholding. In some instances, the GPU 152 enables removal of the FPGA from the waveform acquisition device 140.

Given the foregoing description, the waveform analysis device 150 receives a digitized version of the waveform data with increased data points, and the waveform data for an experiment is displayed and available in its entirety for processing by the GPU 152. In addition to having the capability of processing a large stream or file of waveform data, the GPU 152 enables thresholding the waveform at the post-processing step as opposed to the waveform acquisition step. This in turn provides several technical benefits including the ability to dynamically adjust thresholds and update graphical plots in real-time without re-running an experiment. The GPU 152 may also measure and extract biologically relevant information present in the waveform data beyond the three parameters of height, width, and area. Further details of operation and advantages are discussed below.

The flow cytometer system 100 includes elements which are shown and described for purposes of discussion, and it will be appreciated that numerous variations in components and functions are possible. The optical elements 122 may include a series of filters, dichroic mirrors, and/or beam splitters to select out different wavelengths of light and provide the wavelength to the appropriate detector. The detectors 124 may comprise, for example, photomultiplier tubes (PMTs) or avalanche photodiodes (APDs) or single photon counting devices.

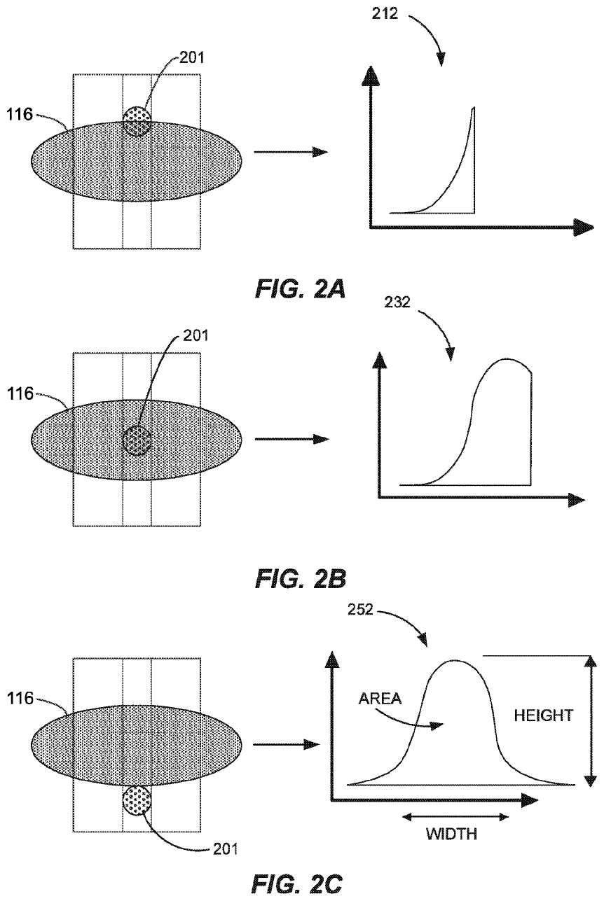

FIGS. 2A-2C illustrate examples of waveform data generated by a particle 201 as it passes through the interrogation zone 116. As the particle 201 passes through the interrogation zone 116, a pulse is detected by one or more of the detectors 124.

FIG. 2A shows an example of the particle 201 entering the interrogation zone 116. As the particle 201 starts to intersect with the interrogation zone 116, the particle 201 begins to generate scattered light and fluorescence signals. The detector 124 produces a current or voltage that is proportional to the scattered light and fluorescence signals. The output of the detector 124 begins to rise as shown in plot 212 due to current flowing in the detector 124.

FIG. 2B shows an example of the particle 201 passing through a central area of the interrogation zone 116. As the particle 201 continues to move through the interrogation zone 116, the particle 201 becomes fully illuminated. Since photon density is highest in the central portion of the interrogation zone 116, a maximum amount of optical signal is produced in this example. As shown in plot 232, the current or voltage of the detector 124 peaks when the particle 201 passes through the central area of the interrogation zone 116.

FIG. 2C shows an example of the particle 201 exiting the interrogation zone 116. As the particle 201 exits the interrogation zone 116, the current or voltage output of the detector 124 returns to the baseline. The generation of the pulse shown in plot 252 is called an event. The height of the plot 252 represents the maximum current/voltage output by the detector 124 which can be proportional to the signal intensity and size of the particle, the width of the plot 252 represents the time it took for the particle to pass through the interrogation zone 116, and the area under the plot 252 can represents the signal intensity and size of the particle. Accordingly, the height, width, and area of the plot 252 can be used to characterize the particle.

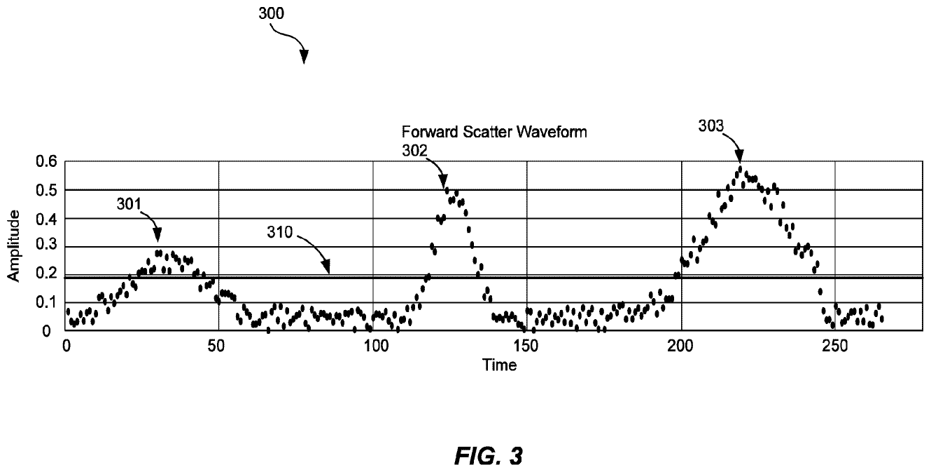

FIG. 3 illustrates an example of waveform data 300 plotted with respect to a threshold value 310. In this illustrative example, the threshold value 310 represents a single constant threshold voltage. As previously described, in traditional polychromatic and spectral flow cytometry, the threshold value 310 is used to specify when the digitization of detector output (e.g., analog waveform data 126) begins. That is, when the waveform data 300 travels above the threshold value 310, the waveform acquisition device begins computing the height, width, and area of each pulse 301-303 that is above the threshold value 310. Waveform data 300 that is below the threshold value 310 is discarded during waveform acquisition in prior techniques.

The problem with the above-described approach is that the threshold value 310 may not be appropriately set for the entire voltage waveform for the purpose of extracting event data. For instance, the threshold value 310 of this example may be set too high to accurately analyze cells generating a pulse similar to the pulse 301 of the waveform data 300. On the other hand, if the threshold value 310 is set too low it may compromise the overall signal-to-noise ratio of the waveform data 300. Additionally, in conventional flow cytometers, the single threshold value must be set prior to data acquisition, irreversibly discarding events of potential relevance.

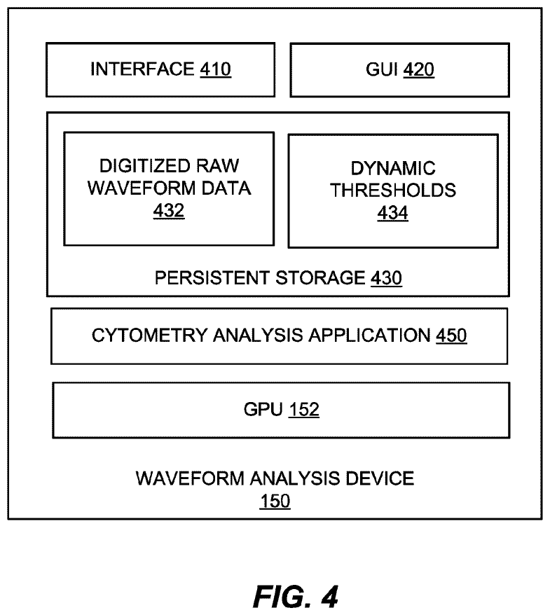

FIG. 4 schematically illustrates an example of the waveform analysis device 150. The waveform analysis device 150 receives, stores, and displays waveform data that has been continuously sampled without having been thresholded upstream at the waveform acquisition device 140. The waveform analysis device 150 includes an interface 410 to receive digitized raw waveform data 432, a persistent storage 430 to store the digitized raw waveform data 432, and can include a graphical user interface (GUI) 420 to display the digitized raw waveform data 432. The persistent storage 430 may also store a plurality of dynamic thresholds 434 that allow for non-linear thresholding and real-time updating and displaying of applied thresholds as further described below. The persistent storage 430 may comprise system memory such as random-access memory (RAM) and/or long-term non-volatile memory such as a hard drive.

The waveform analysis device 150 may further include a cytometry analysis application 450 comprising a software application or a set of related software applications configured to instruct the GPU 152 to process the digitized raw waveform data 432. The cytometry analysis application 450 may execute on one or more processors to provide the functionality described herein in conjunction with the GPU 152 such as receiving user input via the GUI 420. One or more components of the waveform analysis device 150 may reside in a cloud computing application in a network distributed system. In that regard, the waveform analysis device 150 may be any of a variety of computing devices, including, but not limited to, a personal computing device, a server computing device, or a distributed computing device.

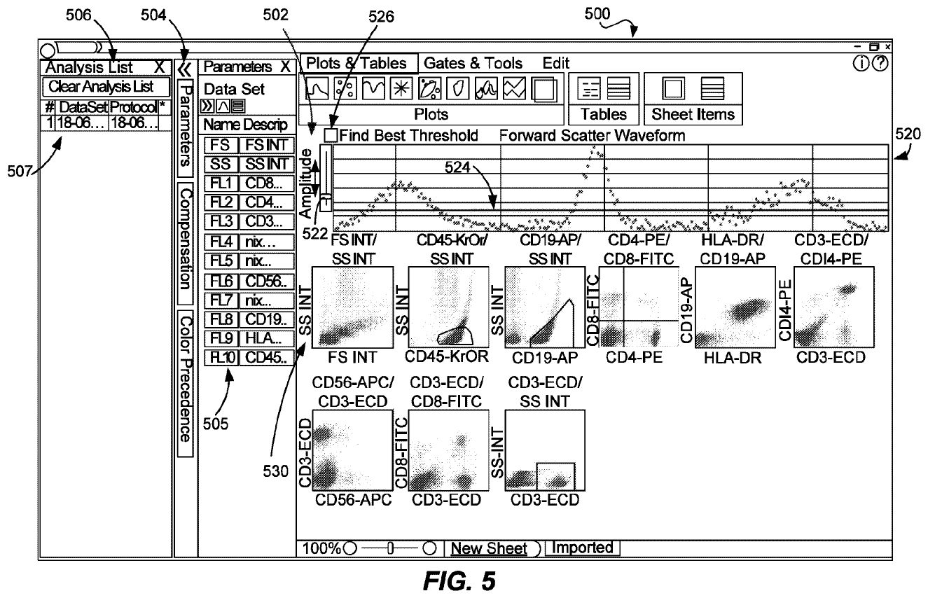

FIG. 5 illustrates an example of a graphical user interface (GUI) 500 that can be generated by the waveform analysis device 150. The GUI 500 includes a waveform display window 502 to display graphs and plots of waveform data, a parameters window 504 for selecting one or more parameters 505 to display in the waveform display window 502, and a data set window 506 to select a file or data set 507 to be processed and displayed.

A user may select a data set 507 stored in persistent storage 430 of the waveform analysis device 150, and select one or more of the parameters 505 to display for the data set 507. A parameter in this context is a measurement from a particular detector 124 of the flow cytometer system 100. The parameters may be used to generate graphs and plots including waveform graphs, histograms, scatter plots, density plots, comparison plots, and the like. In this example, the waveform display window 502 displays a forward scatter waveform 520 and a plurality of scatter plots 530 related to side scatter and fluorescence intensity.

In this example, the GUI 500 includes an adjustable threshold element 522 that can be selected and moved or dragged by a user to adjust a threshold 524 to a higher value or a lower value, as indicated by the double arrow. Each time the threshold 524 is reset or updated in the GUI 500, the GPU 152 applies the new threshold value(s) to the waveform data. The GPU 152 extracts measurements according to the new threshold value(s) and updates each of the graphs and plots displayed in the waveform display window 502 in real-time or near real-time.

The GUI 500 can further include a threshold optimization element 526 which may be selected to automatically determine the threshold value that maximizes the relevant data output of a particular waveform data set while minimizing signal noise. Advantageously, the adjustable threshold element 522 and the threshold optimization element 526 are tools that a user of the flow cytometer system 100 can select to adjust the analysis of the waveform data acquired from the waveform acquisition device 140 without having to re-run an experiment each time different parameters 505 are desired for analyzing and displaying the waveform data.

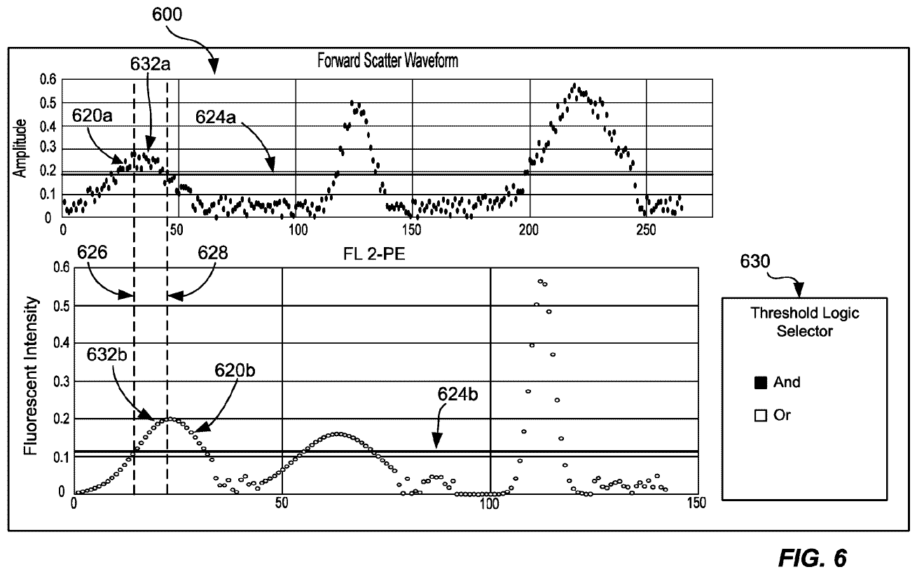

FIG. 6 illustrates another example of a graphical user interface (GUI) 600 generated by the waveform analysis device 150. In this example, the GUI 600 includes a first waveform 620a and a second waveform 620b. The types of waveforms displayed on the GUI may vary depending on the selection of the data set 507 (see FIG. 5). In this example, the first waveform 620a is a forward scatter waveform and the second waveform 620b is a phycoerythrin (PE) waveform. In some examples, the GUI 600 displays more than two waveforms.

In the example of FIG. 6, thresholds 624a, 624b are applied to the first and second waveforms 620a, 620b. In some examples, the thresholds 624a, 624b have the same value. In other examples, the thresholds 624a, 624b have different values.

In further examples, the GUI 600 includes the adjustable threshold element 522 (see FIG. 5) to adjust the thresholds applied to the first and second waveforms 620a, 620b. In further examples, the GUI 600 includes the threshold optimization element 526 to automatically optimize the thresholds applied to the first and second waveforms 620a, 620b.

FIG. 6 further shows first and second markers 626, 628 to illustrate sections 632a, 632b of the first and second waveforms 620a, 620b that are extracted for analysis by the waveform analysis device 150 based on a selection in a threshold logic selector 630 for determining when to begin and end thresholding the first and second waveforms 620a, 620b.

In the example of FIG. 6, the threshold logic selector 630 includes a selection of the logical operator “And” while a logical operator “Or” is unselected. The “And” and “Or” logical operators are examples of Boolean operators. Additional types of Boolean operators such as “Not” and “Exclusive Or” (XOR) can be included in the threshold logic selector 630.

The first marker 626 illustrates a first point in time when both the first waveform 620a and the second waveform 620b are above their respective thresholds 624a, 624b. For example, the first marker 626 does not occur until when both the first and second waveforms 620a, 620b exceed their respective thresholds 624a, 624b even though the first waveform 620a exceeds the threshold 624a before the second waveform 620b exceeds the threshold 624b.

The second marker 628 illustrates a second point in time when both the first waveform 620a and the second waveform 620b are above their respective thresholds 624a, 624b. For example, the second marker 628 occurs when the first waveform 620a begins to dip below the threshold 624a even though the second waveform 620b remains above the threshold 624b.

As shown in FIG. 6, a portion of the first waveform 620a that is above the threshold 624a is not included in the section 632a that is extracted from the first waveform 620a because it occurs before the second waveform 620b begins to exceed the threshold 624b (i.e., before the first marker 626). Also, the second waveform 620b is prematurely cut-off because it occurs after the first waveform 620a dips below the threshold 624a (i.e., after the second marker 628).

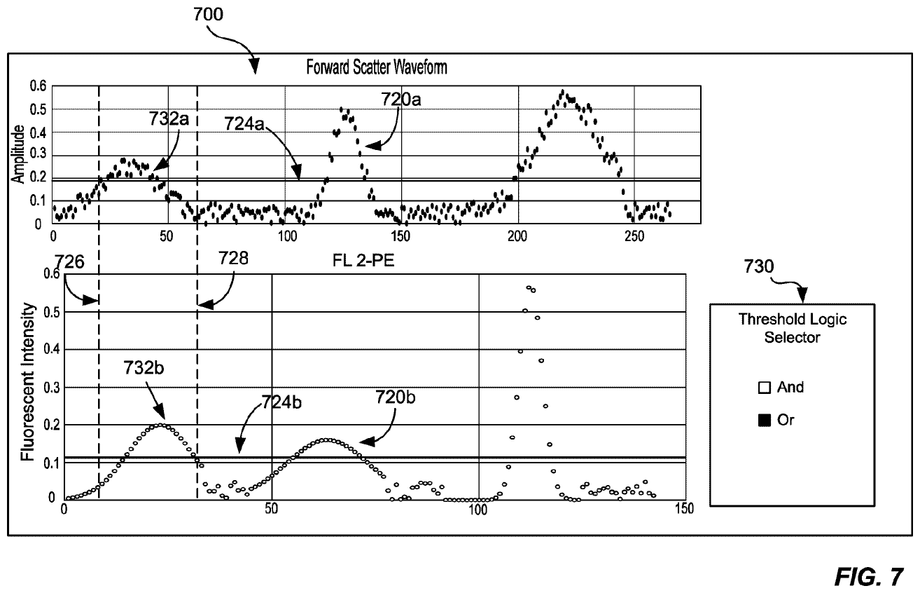

FIG. 7 illustrates another example of a graphical user interface (GUI) 700 generated by the waveform analysis device 150. The GUI 700 includes a first waveform 720a, a second waveform 720b, and a threshold logic selector 730. The types of waveforms displayed on the GUI may vary depending on the selection of the data set 507. In this example, the first waveform 720a is a forward scatter waveform and the second waveform 720b is a phycoerythrin (PE) waveform. In some examples, the GUI 700 displays more than two waveforms.

Like in the example shown in FIG. 6, thresholds 724a, 724b are applied to the first and second waveforms 720a, 720b. In some examples, the thresholds 724a, 724b have the same value. In other examples, the thresholds 724a, 724b have different values.

In further examples, the GUI 700 includes the adjustable threshold element 522 (see FIG. 5) to adjust the thresholds applied to the first and second waveforms 720a, 720b. In further examples, the GUI 700 includes the threshold optimization element 526 to automatically optimize the thresholds applied to the first and second waveforms 720a, 720b.

FIG. 7 further shows first and second markers 726, 728 to illustrate sections 732a, 732b of the first and second waveforms 720a, 720b that are extracted for analysis by the waveform analysis device 150 based on a selection in the threshold logic selector 730 for determining when to begin and end thresholding the first and second waveforms 620a, 620b.

The threshold logic selector 730 includes a selection the logical operator “Or” while the logical operator “And” is unselected in the threshold logic selector 730. These logical operators are examples of Boolean operators. Additional types of Boolean operators such as “Not” and “Exclusive Or” (XOR) can be included in the threshold logic selector 730.

The first marker 726 illustrates a first point when the first waveform 720a is above the threshold 724a or the second waveform 720b is above the threshold 724b. For example, the first marker 726 occurs when the first waveform 720a exceeds the threshold 724a even though the second waveform 720b remains below the threshold 724b such that at least one of the first and second waveforms 720a, 720b is above its respective threshold.

The second marker 728 illustrates a second point when the first waveform 720a is above the threshold 724a or the second waveform 720b is above the threshold 724b. For example, the second marker 728 occurs when the second waveform 720b begins to dip below the threshold 724b (even though the first waveform 720a is already below the threshold 724a) such that the first and second waveforms 720a, 720b are both below their respective thresholds.

As shown in FIG. 7, a portion of the first waveform 720a that is below the threshold 724a is included in the section 732a that is extracted from the first waveform 720a because it occurs while the second waveform 720b remains above the threshold 724b (i.e., before the second marker 728). Also, a portion of the second waveform 720b that is below the threshold 724b is included in the section 732b that is extracted from the second waveform 720b because it occurs when the first waveform 720a is above the threshold 724b (i.e., after the first marker 726).

In view of FIGS. 6 and 7, the threshold logic applied by the flow cytometer system 100 for analyzing waveforms is customizable after the waveforms have been acquired. This eliminates the need to re-run a flow cytometry experiment to collect new data under a different threshold logic, which vastly improves the usability of the flow cytometer system 100. While the logical operators “And” and “Or” are described above with respect to FIGS. 6 and 7, these concepts may similarly be applied to additional types of logical operators such as “Not”, “Exclusive or” (XOR), “If . . . then”, “If and only if”, and the like.

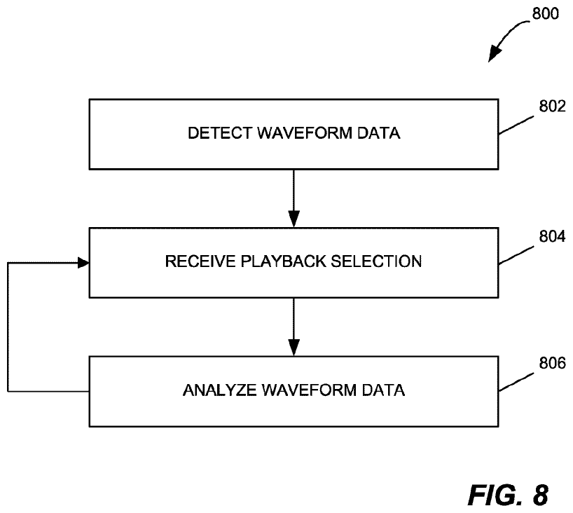

FIG. 8 schematically illustrates an example of a method 800 of providing a flow cytometry analysis by the flow cytometer system 100. The method 800 includes an operation 802 of detecting waveform data from particles passing through the interrogation zone 116 of the light source 102. In operation 802, the waveform data can be detected by the detectors 124 of the optical system 120 in the flow cytometer 101. The waveform data can include both scattered light (e.g., forward scatter and/or side scatter) and various fluorescence wavelengths. In operation 802, the waveform data is detected without thresholding. For example, the waveform data detected in operation 802 can be used to generate continuous waveforms without thresholding the raw data acquired from the waveform acquisition device 140.

Next, the method 800 includes an operation 804 of receiving a playback selection for thresholding the waveform data detected in operation 802. The playback selection can be received via a selection of a logic operator in the threshold logic selectors 630, 730 of FIGS. 6 and 7. For example, the playback selection can include a selection of a logical operator such as “And”, “Or”, “Not”, “Exclusive or” (XOR), “If . . . then”, “If and only if”, and the like.

In some examples, the playback selection received in operation 804 further includes a selection from the adjustable threshold element 522 (see FIG. 5) to adjust the threshold applied to one or more waveforms. In some further examples, the playback selection received in operation 804 further includes a selection from the threshold optimization element 526 (see FIG. 5) to automatically optimize the threshold applied to one or more waveforms.

Next, the method 800 includes an operation 806 of analyzing the waveform data based on the playback selection received in operation 804. Operation 806 can include analyzing the waveform data by applying the logical operator selected in the threshold logic selectors 630, 730 to determine when to begin and end thresholding the waveform data detected in operation 802. For example, selection of the operator “And” causes thresholding to begin when each waveform is above its respective threshold and causes thresholding to end when at least one waveform is below its respective threshold. As another example, selection of the operator “Or” causes thresholding to begin when at least one waveform is above its respective threshold and causes thresholding to end when each waveform is below its respective threshold.

As another illustrative example, operation 806 can include analyzing the waveform data by applying one or more thresholds based on one or more selections of the adjustable threshold element 522 to the waveform data. In some examples, different thresholds are applied to different sets of waveform data based on the one or more selections of the adjustable threshold element 522 for each set of waveform data detected in operation 802.

As another illustrative example, operation 806 can include analyzing the waveform data by applying one or more optimal thresholds based on one or more selections of the threshold optimization element 526 to the waveform data. In some examples, different optimal thresholds are applied to different sets of waveform data based on the one or more selections of the threshold optimization element 526 for each set of waveform data detected in operation 802.

Operation 806 can include displaying one or more waveforms and/or analyses of the waveform data based on the threshold logic received in operation 804. As an illustrative example, operation 806 can include displaying the one or more waveforms and/or analyses of the waveform data based on a logical operator selection received in the threshold logic selector 630, 730 such as the logical operator “And” or the logical operator “Or”, described in the examples above.

As shown in FIG. 8, operations 804, 806 can be repeated as many times as desired by a user of the flow cytometer system 100 without having to initiate a new flow cytometry experiment to acquire additional waveform data (i.e., without having to repeat the operation 802 of the method 800). Instead, the user of the flow cytometer system 100 can change the playback selections and/or provide new playback selections (operation 804) for the waveform analysis device 150 to analyze and display the one or more waveforms and/or analyses (operation 806) based on the logical operators selected in the threshold logic selector 630, 730 such as according to Boolean operators described above. The method 800 improves the usability and flexibility of the flow cytometer system 100 because the user does not have to re-run the flow cytometry experiment each time a new logic is desired for analyzing the waveform data.

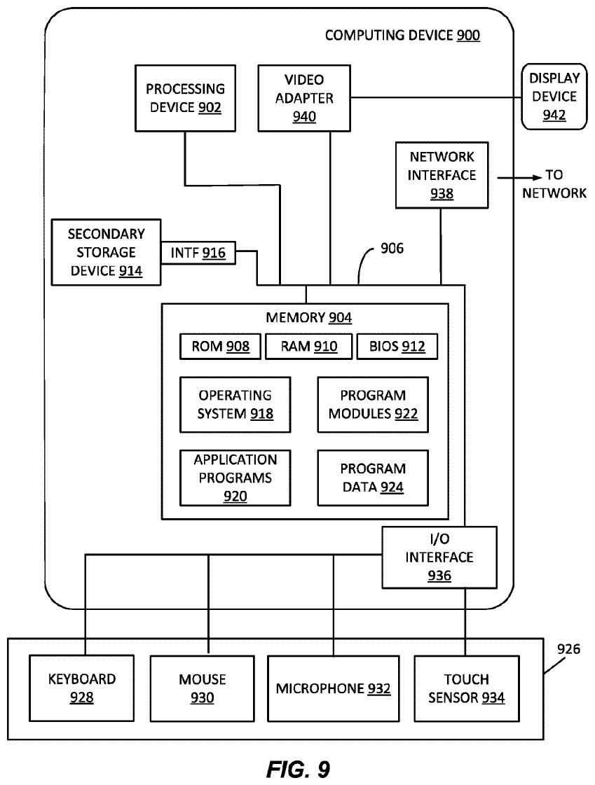

FIG. 9 illustrates an exemplary architecture of a computing device 900 that can be used to implement aspects of the present disclosure, including the waveform analysis device 150. The computing device illustrated in FIG. 9 can be used to execute the operating system, application programs, and software modules (including the software engines) described herein.

The computing device 900 includes at least one processing device 902, such as a central processing unit (CPU). In this example, the computing device 900 also includes a system memory 904, and a system bus 906 that couples various system components including the system memory 904 to the at least one processing device 902. The system bus 906 is one of any number of types of bus structures including a memory bus, or memory controller; a peripheral bus; and a local bus using any of a variety of bus architectures.

The system memory 904 includes read only memory (ROM) 908 and random-access memory (RAM) 910. A basic input/output system 912 containing the basic routines that act to transfer information within computing device 900, such as during start up, is typically stored in the read only memory 908. In some examples, the system memory 904 has a large memory capacity, such as equal to or greater than one Terabyte of RAM. The RAM can be used to load and subsequently analyze the waveform data (e.g., the raw waveform data, such as stored in a raw waveform data file, which can include digitalized waveform data).

The computing device 900 also includes a secondary storage device 914 in some embodiments, such as a hard disk drive, for storing digital data. The secondary storage device 914 is connected to the system bus 906 by a secondary storage interface 916. In some examples, the secondary storage devices 914 and their associated computer readable media provide nonvolatile storage of computer readable instructions (including application programs and program modules), data structures, and other data for the computing device 900.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

Any number of program modules can be stored in secondary storage device 914 or system memory 904, including an operating system 918, one or more application programs 920, other program modules 922 (e.g., software engines described herein), and program data 924. The computing device 900 can utilize any suitable operating system, such as Microsoft Windows™, Google Chrome™, Apple OS, and any other operating system suitable for a computing device.

In some examples, a user provides inputs to the computing device 900 through one or more input devices 926. Examples of input devices 926 include a keyboard 928, mouse 930, microphone 932, and touch sensor 934 (such as a touchpad or touch sensitive display). Additional examples include additional types of input devices 926, or fewer types of input devices 926. The input devices 926 are connected to the at least one processing device 902 through an input/output interface 936 coupled to the system bus 906. The input/output interface 936 can include any number of input/output interfaces, such as a parallel port, serial port, game port, or a universal serial bus. Wireless coupling between input devices 926 and the input/output interface 936 is possible as well, such as through infrared, BLUETOOTH®, 802.11a/b/g/n, cellular, or other radio frequency communication systems in some possible embodiments.

In this example embodiment, a display device 942, such as a monitor, liquid crystal display device, projector, or touch sensitive display device, is also connected to the system bus 906 via a video adapter 940. In addition to the display device 942, the computing device 900 can include various other peripheral devices (not shown), such as speakers or a printer.

When used in a local area networking environment or a wide area networking environment (such as the Internet), the computing device 900 is typically connected to a network such as through a network interface 938, such as an Ethernet interface. Other possible embodiments use other communication devices. For example, some embodiments of the computing device 900 include a modem for communicating across the network.

The computing device 900 typically includes at least some form of computer readable media. Computer readable media includes any available media that can be accessed by the computing device 900. By way of example, computer readable media include computer readable storage media and computer readable communication media.

Computer readable storage media includes volatile and nonvolatile, removable, and non-removable media implemented in any device configured to store information such as computer readable instructions, data structures, program modules or other data. Computer readable storage media includes, but is not limited to, random access memory, read only memory, electrically erasable programmable read only memory, flash memory, compact disc read only memory, digital versatile disks or other optical storage, magnetic cassettes, magnetic tape, magnetic disk storage or other magnetic storage devices, or any other medium that can be used to store the desired information and that can be accessed by the computing device. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device 900 is an example of programmable electronics, which may include one or more such computing devices, and when multiple computing devices are included, such computing devices can be coupled together with a suitable data communication network to collectively perform the various functions, methods, or operations disclosed herein.

Although specific embodiments are described herein, the scope of the disclosure is not limited to those specific embodiments. The scope of the disclosure is defined by the following claims and any equivalents thereof.

What is claimed is:

1. A flow cytometry system for analyzing particles, the flow cytometry system comprising:
a light source for generating a light beam toward an interrogation zone;
an optical system including detectors for detecting radiated light from particles passing through the light beam in the interrogation zone; and
a processing circuitry having non-transitory computer readable storage media storing instructions which, when executed by the processing circuity, cause the processing circuitry to:
detect waveform data from the particles passing through the interrogation zone, the waveform data detected without thresholding;
receive a playback selection including a logical operator for determining when to begin thresholding the waveform data after detection; and
analyze the waveform data based on the playback selection.

2. The flow cytometry system of claim 1, wherein the non-transitory computer readable storage media store additional instructions which, when executed by the processing circuitry, further cause the processing circuitry to:
receive a second playback selection including a second logical operator for determining when to begin and end thresholding the waveform data after detection; and
analyze the waveform data based on the second playback selection without initiating a new flow cytometry experiment to detect additional waveform data.

3. The flow cytometry system of claim 1, wherein the logical operator is selected from the group consisting of And, Or, Not, and Exclusive Or (XOR).

4. The flow cytometry system as in any of claims 1-3, wherein the waveform data includes forward scatter, side scatter, and fluorescence wavelengths.

5. The flow cytometry system as in any of claims 1-4, wherein the non-transitory computer readable storage media store additional instructions which, when executed by the processing circuitry, further cause the processing circuitry to:
display two or more waveforms based on the playback selection.

6. A method of performing a flow cytometry analysis, the method comprising:
detecting waveform data from particles passing through an interrogation zone, the waveform data detected without thresholding;
receiving a playback selection including a logical operator for determining when to begin thresholding the waveform data after detection; and
analyzing the waveform data based on the playback selection.

7. The method of claim 6, further comprising:
receiving a second playback selection including a second logical operator for determining when to begin and end thresholding the waveform data after detection; and
analyzing the waveform data based on the second playback selection without initiating a new flow cytometry experiment to detect additional waveform data.

8. The method of claim 6, wherein the logical operator is selected from the group consisting of And, Or, Not, and Exclusive Or (XOR).

9. The method as in any of claims 6-8, wherein the waveform data includes forward scatter, side scatter, and fluorescence wavelengths.

10. The method as in any of claims 6-9, further comprising:
displaying two or more waveforms based on the playback selection.

11. A non-transitory computer readable medium comprising program instructions, which when executed by a processor, cause the processor to:
detect waveform data from particles passing through an interrogation zone, the waveform data detected without thresholding;
receive a playback selection including a logical operator for determining when to begin thresholding the waveform data after the waveform data is detected; and
analyze the waveform data based on the playback selection.

12. The non-transitory computer readable medium of claim 11, further comprising additional program instructions, which when executed by a processor, further cause the processor to:
receive a second playback selection including a second logical operator for determining when to begin and end thresholding the waveform data after detection; and
analyze the waveform data based on the second playback selection without initiating a new flow cytometry experiment to detect additional waveform data.

13. The non-transitory computer readable medium of claim 11, wherein the logical operator is selected from the group consisting of And, Or, Not, and Exclusive Or (XOR).

14. The non-transitory computer readable medium as in any of claims 11-13, wherein the waveform data includes forward scatter, side scatter, and fluorescence wavelengths.

15. The non-transitory computer readable medium as in any of claims 11-14, further comprising program instructions, which when executed by a processor, further cause the processor to:
display two or more waveforms based on the playback selection.
